(19) United States
(12) Patent Application Publication
(10) Pub. No.: US 2006/0223540 A1
(43) Pub. Date: Oct. 5, 2006

(54) Progressive reuse partitioning for improved interference resection in wireless packet networks

(76) Inventors: Justin Che-I Chuang, Holmdel, NJ (US); Shailender B. Timiri, Bellevue, WA (US)

Correspondence Address: Law Firm of Peter V.D. Wilde, 301 East Landing, Williamsburg, VA, 23185, US

(21) Appl. No.: 11/094,933

(22) Filed: Mar. 31, 2005

(51) Int. Cl. H04Q 7/20

(52) U.S. Cl. 455/450; 455/453; 455/67.11

(57) ABSTRACT

A method for radio resource allocation based on planned priority ordering to realize the maximum carrier to interference ratio (C/I) in a cellular system that employs frequency reuse. Reuse of co-channel resources is progressively increased as traffic load increases based on the available spectrum. By using this method, interference rejection at light loading can approach that obtainable by using a low reuse factor. When applied to a wireless packet network, this method allows each resource to carry highest throughput according to the traffic demand and available bandwidth, while making more resources available to carry additional traffic when system loading is increased.

### BACKGROUND OF THE INVENTION

The present invention generally relates to the field of communication networks and more particularly, is directed to a method for radio resource allocation based on planned priority ordering for improving interference rejection in a wireless packet network.

As known in the prior art, wireless cellular networks load radio resources in each cell often reuse resources amongst co-channel cells. In allocating resources, current fixed assignment methods either over-designs the reuse factor, which requires high bandwidth for deployment or limits system capacity, or employs a low reuse factor which does not provide sufficient interference protection. Most proposed adaptive or dynamic channel assignment methods require elaborate measurement procedure to determine the best channel to assign, which either complicates implementation or requires modifications to the existing standards.

Accordingly, there is a need in the art for a more efficient method of allocation of resources in wireless cellular networks.

### SUMMARY OF THE INVENTION

The present invention introduces a novel method for radio resource allocation based on planned priority ordering to realize the maximum carrier to interference ration (C/I) in a cellular system that employs frequency reuse. Reuse of co-channel resources is progressively increased as traffic load increases based on the available spectrum. By using this method, interference rejection at light loading can approach that obtainable by using a low reuse factor. When applied to a wireless packet network, this method allows each resource to carry highest throughput according to the traffic demand and available bandwidth, while making more resources available to carry additional traffic when system loading is increased.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a graph comparing Classic versus Compact performance of the present invention for 2.4 MHz scenarios; and

FIG. 2 is a graph comparing Classic versus Compact performance of the present invention for 4.2 MHz scenarios.

### BRIEF DESCRIPTION OF THE PREFERRED EMBODIMENT

The present invention, permits the prioritized loading of radio resources in each cell of a wireless network such that reuse of these resources is minimized amongst the co-channel calls. This ensures that the C/Is realized are optimally high under the worst-case condition of uniform loading across cells.

In the case where a radio resources is a time slot. The co-channel cells and their timeslots are divided into m=2 co-channel sub-groups and 2 timeslot sets respectively. Note that m<_N, the total number of con-channel slots. Each cell sub-group is assigned a unique, pre-determined, priority ordering of the timeslot sets. The cell assigns the available resources according to the timeslot set priority order and the slot ordering within the timeslot set. As loading is uniformly increased across the cells, the reuse factor progressively decreases as m, m/2, m/4 . . . , and 1. The attached paper describes the detailed algorithm and providing some examples.

Conventional reuse planning achieves a good C/I only if high reuse factor is employed, which requires a high total spectrum for initial deployment. On the other hand, a low reuse factor allows deployment of services with minimum stat-up bandwidth at the cost of lower interference rejection. The technique of the present invention, permits service providers to have a good balance between these tow extremes:
(1) When a small bandwidth is available, the system can have initial deployment with a reuse of 1.
(2) As more spectrum is made available such that, e.g., N>m slots are available, good throughput provided by reuse factor as high as m can be achieved when a small percentage of subscribes is simultaneously accessing the system.

The system allows more subscribers to share spectrum with a lower reuse factor as demand increases. When system is highly loaded, the high efficiency of reuse 1 is achieved, serving the highest number of subscribers. By implementing this method in the packet wireless systems, such as EDGE, a service provider may offer the best services achievable for a given number of active users based on the available spectrum.

The following description of the present invention assumes that the unit of resource is a single periodically recurring timeslot on a RF channel and that co-channel cells in the system are uniformly loaded for optimally high C/Is to be realized.

It is also assumed that:
1. The priority ordering of slots within each co-channel cell is fixed and unchanging i.e. not dynamic or adaptive. In other words, it is not measurement-driven and there is no requirement for reordering or reallocation of the slots although these are not precluded; and
2. The priority ordering must maintain contiguity of slots. This provides for efficient multi-slot operation. It also permits all slots of a RF channel to be filled before the next RF channel is used minimizing co-channel interference, especially in systems where transmissions are not synchronized.

In accordance with the present invention, co-channel cells and their timeslots are divided into 2ⁿ co-channel sub-groups and 2ⁿ timeslot sets respectively. Note that 2ⁿ≦N, the total number of co-channel slots. The co-channel sub-groups are C₁, C₂, . . . Cₘ (adjacent sub-groups being the nearest neighbors) and the timeslot sets are 1, 2, . . . m where, m=2ⁿ.m is the initial and most sparse reuse factor.

The timeslots are numbered sequentially one RF channel at a time. Timeslot sets are such that the union of sequentially numbered timeslot sets is a set of sequentially numbered timeslots.

### EXAMPLE 1

Given RF channels RF1, RF2 and RF3, each with 8 timeslots. Therefore, the total number of slots, N=24 slots. The timeslot numbers can be assigned as follows:

RF1=Timeslots 1, 2, 3, 4, 5, 6, 7, 8

RF2=Timeslots 9, 10, 11, 12, 13, 14, 15, 16

RF3=Timeslots 17, 18, 19, 20, 21, 22, 23, 24

Assume 4 timeslot sets are required (m=4). Therefore, each contains N/m=24/4=6 slots. These can be defined as:

Timeslot set 1=1, 2, 3, 4, 5, 6

Timeslot set 2=7, 8, 9, 10, 11, 12

Timeslot set 3=13, 14, 15, 16, 17, 18

Timeslot set 4=19, 20, 21, 22, 23, 24

The timeslot numbering within a timeslot set determines the priority ordering within the timeslot set. Ascending or descending order is indicated by the presence (descending) or absence (ascending) of a prime symbol, ′″″, as a superscript on the timeslot set number.

Each cell sub-group is assigned a unique, pre-determined, priority ordering of the timeslot sets. The cell assigns the available resources according to the timeslot set priority order and the slot ordering within the timeslot set. As loading is uniformly increased across the cells, the reuse factor progressively decreases as m , m/2, m/4 . . . 1.

A method of determining the priority ordering of the timeslot sets will be described below. The following sections examples describe the co-channel sub-groups and corresponding ordered list of timeslot sets. Table 1 below shows co-channel cell sub-groups and timeslots sets for initial reuse where m=4.

TABLE 1

| | |
|---|---|
| Cell Sub-group | Timeslot Sets(Decreasing priority → ) |

| | | | | |
|---|---|---|---|---|
| C₁ | 1 | 2 | 3 | 4 |
| C₂ | 3 | 4 | 2′ | 1′ |
| C₃ | 2′ | 1′ | 3 | 4 |
| C₄ | 4′ | 3′ | 2′ | 1′ |

### EXAMPLE 2

For N=28 timeslots,

| set 1 = Slots(ascending order) 1→7; | set 1′ = Slots(descending order) |
|---|---|
| | 7→1 |
| set 2 = Slots(ascending order) 8→14; | set 2′ = Slots(descending order) |
| | 14→8 |
| set 3 = Slots (ascending order) 15→21; | set 3′ = Slots (descending order) |
| | 21→15 |
| set 4 = Slots(ascending order) 22→28; | set 4′ = Slots (descending order) |
| | 28→22 |

### EXAMPLE 3

For N=52 timeslots,

| set 1 = Slots(ascending order) 1→13; | set 1′ = Slots(descending order) |
|---|---|
| | 13→1 |
| set 2 = Slots(ascending order) 14→26; | set 2′ = Slots (descending order) |
| | 26→14 |
| set 3 = Slots(ascending order) 27→39; | set 3′ = Slots (descending order) |
| | 39→27 |
| set 4 = Slots(ascending order) 40→52; | set 4′ = Slots (descending order) |
| | 52→40 |

Table 2 below shows co-channel cell sub-groups and timeslots sets for initial reuse where m=8.

TABLE 2

| | Timeslot Sets (Decreasing priority →) | | | | | | | |
|---|---|---|---|---|---|---|---|---|
| Cell Sub-group | T₁ | T₂ | T₃ | T₄ | T₅ | T₆ | T₇ | T₈ |
| C₁ | 1 | 2 | 3 | 4 | 5 | 6 | 7 | 8 |
| C₂ | 5 | 6 | 7 | 8 | 4′ | 3′ | 2′ | 1′ |
| C₃ | 3 | 4 | 2′ | 1′ | 5 | 6 | 7 | 8 |
| C₄ | 7 | 8 | 6′ | 5′ | 4′ | 3′ | 2′ | 1′ |
| C₅ | 2′ | 1′ | 3 | 4 | 5 | 6 | 7 | 8 |
| C₆ | 6′ | 5′ | 7 | 8 | 4′ | 3′ | 2′ | 1′ |
| C₇ | 4′ | 3′ | 2′ | 1′ | 5 | 6 | 7 | 8 |
| C₈ | 8 | 7′ | 6′ | 5′ | 4′ | 3′ | 2′ | 1′ |

### EXAMPLE 4

For N=28 timeslots,

| set 1 = Slots(ascending order) 1→4; | set 1′ = Slots(descending order) |
|---|---|
| | 4→1 |
| set 2 = Slots(ascending order) 5→8; | set 2′ = Slots(descending order) |
| | 8→5 |
| set 3 = Slots(ascending order) 9→12; | set 3′ = Slots(descending order) |
| | 12→49 |
| set 4 = Slots(ascending order) 13→16; | set 4′ = Slots(descending order) |
| | 16→13 |
| set 5 = Slots(ascending order) 17→19; | set 5′ = Slots(descending order) |
| | 19→17 |
| set 6 = Slots(ascending order) 20→22; | set 5′ = Slots(descending order) |
| | 22→20 |
| set 7 = Slots(ascending order) 23→25; | set 7′ = Slots(descending order) |
| | 25→23 |
| set 8 = Slots(ascending order) 26→28; | set 8′ = Slots(descending order) |
| | 28→26 |

### EXAMPLE 5

For N=52 timeslots,

| set 1 = Slots (ascending order) 1→7; | set 1′ = Slots (descending order) |
|---|---|
| | 7→1 |
| set 2 = Slots (ascending order) 8→14; | set 2′ = Slots (descending order) |
| | 14→8 |
| set 3 = Slots (ascending order) 15→21; | set 3′ = Slots (descending order) |
| | 21→15 |
| set 4 = Slots (ascending order) 22→28; | set 4′ = Slots (descending order) |
| | 28→22 |
| set 5 = Slots (ascending order) 29→34; | set 5′ = Slots (descending order) |
| | 34→29 |
| set 6 = Slots (ascending order) 35→40; | set 6′ = Slots (descending order) |
| | 40→35 |
| set 7 = Slots (ascending order) 41→46; | set 7′ = Slots (descending order) |
| | 46→41 |
| set 8 = Slots (ascending order) 47→52; | set 8′ = Slots (descending order) |
| | 52→47 |

Table 3 below shows co-channel cell sub-groups and timeslots sets for initial reuse where m=16.

TABLE 3

| | Timeslot Sets (Decreasing priority →) | | | | | | | | | | | | | | | |
|---|---|---|---|---|---|---|---|---|---|---|---|---|---|---|---|---|
| Cell Sub-group | T₁ | T₂ | T₃ | T₄ | T₅ | T₆ | T₇ | T₈ | T₉ | T₁₀ | T₁₁ | T₁₂ | T₁₃ | T₁₄ | T₁₅ | T₁₆ |
| C₁ | 1 | 2 | 3 | 4 | 5 | 6 | 7 | 8 | 9 | 10 | 11 | 12 | 13 | 14 | 15 | 16 |
| C₂ | 9 | 10 | 11 | 12 | 13 | 14 | 15 | 16 | 8′ | 7′ | 6′ | 5′ | 4′ | 3′ | 2′ | 1′ |
| C₃ | 5 | 6 | 7 | 8 | 4′ | 3′ | 2′ | 1′ | 9 | 10 | 11 | 12 | 13 | 14 | 15 | 16 |
| C₄ | 13 | 14 | 15 | 16 | 12′ | 11′ | 1O′ | 9′ | 8′ | 7′ | 6′ | 5′ | 4′ | 3′ | 2′ | 1′ |
| C₅ | 3 | 4 | 2′ | 1′ | 5 | 6 | 7 | 8 | 9 | 10 | 11 | 12 | 13 | 14 | 15 | 16 |
| C₆ | 11 | 12 | 10′ | 9′ | 13 | 14 | 15 | 16 | 8′ | 7′ | 6′ | 5′ | 4′ | 3′ | 2′ | 1′ |
| C₇ | 7 | 8 | 6′ | 5′ | 4′ | 3′ | 2′ | 1′ | 9 | 10 | 11 | 12 | 13 | 14 | 15 | 16 |
| C₈ | 15 | 16 | 14′ | 13′ | 12′ | 11′ | 10′ | 9′ | 8′ | 7′ | 6′ | 5′ | 4′ | 3′ | 2′ | 1′ |
| C₉ | 2′ | 1′ | 3 | 4 | 5 | 6 | 7 | 8 | 9 | 10 | 11 | 12 | 13 | 14 | 15 | 16 |
| C₁₀ | 10′ | 9′ | 11 | 12 | 13 | 14 | 15 | 16 | 8′ | 7′ | 6′ | 5′ | 4′ | 3′ | 2′ | 1′ |
| C₁₁ | 6′ | 5′ | 7 | 8 | 4′ | 3′ | 2′ | 1′ | 9 | 10 | 11 | 12 | 13 | 14 | 15 | 16 |
| C₁₂ | 14′ | 13′ | 15 | 16 | 12′ | 11′ | 10′ | 9′ | 8′ | 7′ | 6′ | 5′ | 4′ | 3′ | 2′ | 1′ |
| C₁₃ | 4′ | 3′ | 2′ | 1′ | 5 | 6 | 7 | 8 | 9 | 10 | 11 | 12 | 13 | 14 | 15 | 16 |
| C₁₄ | 12′ | 11′ | 10′ | 9′ | 13 | 14 | 15 | 16 | 8′ | 7′ | 6′ | 5′ | 4′ | 3′ | 2′ | 1′ |
| C₁₅ | 8′ | 7′ | 6′ | 5′ | 4′ | 3′ | 2′ | 1′ | 9 | 10 | 11 | 12 | 13 | 14 | 15 | 16 |
| C₁₆ | 16′ | 15′ | 14′ | 13′ | 12′ | 11′ | 10′ | 9′ | 8′ | 7′ | 6′ | 5′ | 4′ | 3′ | 2′ | 1′ |

### EXAMPLE 6

For N=28 timeslots,

| | |
|---|---|
| set 1 = Slots (ascending order) 1→2; | set 1′ = Slots (descending |
| | order) 2→1 |
| set 2 = Slots (ascending order) 3→4; | set 2′ = Slots (descending |
| | order) 4→3 |
| set 3 = Slots (ascending order) 5→6; | set 3′ = Slots (descending |
| | order) 6→5 |
| set 4 = Slots (ascending order) 7→8; | set 4′ = Slots (descending |
| | order) 8→7 |
| set 5 = Slots (ascending order) 9→10; | set 5′ = Slots (descending |
| | order) 10→9 |
| set 6 = Slots (ascending order) 11→12; | set 6′ = Slots (descending |
| | order) 12→11 |
| set 7 = Slots (ascending order) 13→14; | set 7′ = Slots (descending |
| | order) 14→13 |
| set 8 = Slots (ascending order) 15→16; | set 8′ = Slots (descending |
| | order) 16→15 |
| set 9 = Slots (ascending order) 17→18; | set 9′ = Slots (descending |
| | order) 18→17 |
| set 10 = Slots (ascending order) 19→20; | set 10′ = Slots (descending |
| | order) 20→19 |
| set 11 = Slots (ascending order) 21→22; | set 11′ = Slots (descending |
| | order) 22→21 |
| set 12 = Slots (ascending order) 23→24; | set 124′ = Slots (descending |
| | order) 24→23 |
| set 13 = Slots (ascending order) 25; | set 13′ = Slots (descending |
| | order) 25 |
| set 14 = Slots (ascending order) 26; | set 14′ = Slots (descending |
| | order) 26 |
| set 15 = Slots (ascending order) 27; | set 15′ = Slots (descending |
| | order) 27 |
| set 16 = Slots (ascending order) 28; | set 16′ = Slots (descending |
| | order) 28 |

### EXAMPLE 7

For N=52 timeslots,

| | |
|---|---|
| set 1 = Slots (ascending order) 1→4; | set 1′ = Slots (descending |
| | order) 4→1 |
| set 2 = Slots (ascending order) 5→8; | set 2′ = Slots (descending |
| | order) 8→5 |
| set 3 = Slots (ascending order) 9→12; | set 3′ = Slots (descending |
| | order) 12→9 |
| set 4 = Slots (ascending order) 13→16; | set 4′ = Slots (descending |
| | order) 16→13 |
| set 5 = Slots (ascending order) 17→19; | set 5′ = Slots (descending |
| | order) 19→17 |
| set 6 = Slots (ascending order) 20→22; | set 6′ = Slots (descending |
| | order) 22→20 |
| set 7 = Slots (ascending order) 23→25; | set 7′ = Slots (descending |
| | order) 25→23 |
| set 8 = Slots (ascending order) 26→28; | set 8′ = Slots (descending |
| | order) 28→26 |
| set 9 = Slots (ascending order) 29→31; | set 9′ = Slots (descending |
| | order) 31→29 |
| set 10 = Slots (ascending order) 32→34; | set 10′ = Slots (descending |
| | order) 34→32 |
| set 11 = Slots (ascending order) 35→37; | set 11′ = Slots (descending |
| | order) 37→35 |
| set 12 = Slots (ascending order) 38→40; | set 12′ = Slots (descending |
| | order) 40→38 |
| set 13 = Slots (ascending order) 41→43; | set 13′ = Slots (descending |
| | order) 43→41; |
| set 14 = Slots (ascending order) 44→46; | set 14′ = Slots (descending |
| | order) 46→44; |
| set 15 = Slots (ascending order) 47→49; | set 15′ = Slots (descending |
| | order) 49→47; |
| set 16 = Slots (ascending order) 50→52; | set 16′ = Slots (descending |
| | order) 52→50; |

Various algorithms are possible for determining the priority ordering described above. One such algorithm will now be described. The table is treated as a two-dimensional matrix with table entries being entries in the corresponding position of the matrix.
1. Determine m, such that m≦N. the total number of slots per co-channel cell and m=2ⁿ for integer n. m is the initial reuse factor.
2. Create a 1×m matrix and seed it with the sequential list 1, 2, . . . , m; one number per entry in the row
3. Initialize the iteration variable, i=1 and Z₁=[Ø]
4. Expand the matrix iteratively using the expansion defined below, until at termination a m×m matrix results:

$${M}_{i} = [ \begin{matrix}{X}_{i} & {Y}_{i} & {Z}_{i}\end{matrix} ]$$

$$\begin{matrix}{M}_{i + 1} = [ \begin{matrix}{X}_{i} & {Y}_{i} & {Z}_{i} \\ {Y}_{i} & {( {AX}_{i} )}^{′} & {Z}_{i}\end{matrix} ] \\ = [ \begin{matrix}{X}_{i + 1} & {Y}_{i + 1} & {Z}_{i + 1} ]\end{matrix}\end{matrix}$$

$${Z}_{i + 1} = [ \begin{matrix}{Y}_{i} & {Z}_{i} \\ {( {AX}_{i} )}^{′} & {Z}_{i}\end{matrix} ] , {Z}_{i} = [ ϕ ]$$

$$where , A = [ \begin{matrix}0 & … & 0 & 1 \\ 0 & … & 1 & 0 \\ 0 & 1 & 0 & 0 \\ 1 & 0 & … & 0\end{matrix} ]$$

=standard matrix for the matrix transformation, T(X)=AX, which reverses the elements within each row of X
dimension of Xᵢ=dimension of Yᵢ
Apply primes to all even-numbered entries in the left-most column.

### EXAMPLE 8

This example illustrates the use of the algorithm in the derivation of Table 2

$$Step 1 \text{:}$$

$$Let m = N = {2}^{3} = 8$$

$$Step 2 \text{:}$$

$${M}_{1} = [ \begin{matrix}1 & 2 & 3 & 4 & 5 & 6 & 7 & 8\end{matrix} ] ;$$

$${X}_{1} = [ \begin{matrix}1 & 2 & 3 & 4\end{matrix} ] , {Y}_{1} = [ \begin{matrix}5 & 6 & 7 & 8\end{matrix} ] , {Z}_{1} = [ ϕ ]$$

$$Step 3 \text{:}$$

$${M}_{2} = [ \begin{matrix}1 & 2 & 3 & 4 & 5 & 6 & 7 & 8 \\ 5 & 6 & 7 & 8 & {4}^{′} & {3}^{′} & {2}^{′} & {1}^{′}\end{matrix} ] ;$$

$${X}_{2} = [ \begin{matrix}1 & 2 \\ 5 & 6\end{matrix} ] , {Y}_{2} = [ \begin{matrix}3 & 4 \\ 7 & 8\end{matrix} ] , {Z}_{2} = [ \begin{matrix}5 & 6 & 7 & 8 \\ {4}^{′} & {3}^{′} & {2}^{′} & {1}^{′}\end{matrix} ]$$

$$Step 4 \text{:}$$

$${M}_{3} = [ \begin{matrix}1 & 2 & 3 & 4 & 5 & 6 & 7 & 8 \\ 5 & 6 & 7 & 8 & {4}^{′} & {3}^{′} & {2}^{′} & {1}^{′} \\ 3 & 4 & {2}^{′} & {1}^{′} & 5 & 6 & 7 & 8 \\ 7 & 8 & {6}^{′} & {5}^{′} & {4}^{′} & {3}^{′} & {2}^{′} & {1}^{′}\end{matrix} ] ;$$

$${X}_{3} = [ \begin{matrix}1 \\ 5 \\ 6 \\ 7\end{matrix} ] , {Y}_{3} = [ \begin{matrix}2 \\ 6 \\ 4 \\ 8\end{matrix} ] , {Z}_{3} = [ \begin{matrix}3 & 4 & 5 & 6 & 7 & 8 \\ 7 & 8 & {4}^{′} & {3}^{′} & {2}^{′} & {1}^{′} \\ {2}^{′} & {1}^{′} & 5 & 6 & 7 & 8 \\ {6}^{′} & {5}^{′} & {4}^{′} & {3}^{′} & {2}^{′} & {1}^{′}\end{matrix} ]$$

$$Step 5 \text{:}$$

$${M}_{4} = [ \begin{matrix}1 & 2 & 3 & 4 & 5 & 6 & 7 & 8 \\ 5 & 6 & 7 & 8 & {4}^{′} & {3}^{′} & {2}^{′} & {1}^{′} \\ 3 & 4 & {2}^{′} & {1}^{′} & 5 & 6 & 7 & 8 \\ 7 & 8 & {6}^{′} & {5}^{′} & {4}^{′} & {3}^{′} & {2}^{′} & {1}^{′} \\ 2 & {1}^{′} & 3 & 4 & 5 & 6 & 7 & 8 \\ 6 & {5}^{′} & 7 & 8 & {4}^{′} & {3}^{′} & {2}^{′} & {1}^{′} \\ 4 & {3}^{′} & {2}^{′} & {1}^{′} & 5 & 6 & 7 & 8 \\ 8 & {7}^{′} & {6}^{′} & {5}^{′} & {4}^{′} & {3}^{′} & {2}^{′} & {1}^{′}\end{matrix} ] ;$$

$${X}_{ 4} = [ ϕ ] , {Y}_{4} = [ ϕ ] , {Z}_{ 4} = {M}_{ 4}$$

$$Step 6 \text{:} In the left - most column apply primes to$$

$$all even \text{-} numbered enteries . \\ {M}_{4} = [ \begin{matrix}1 & 2 & 3 & 4 & 5 & 6 & 7 & 8 \\ 5 & 6 & 7 & 8 & {4}^{′} & {3}^{′} & {2}^{′} & {1}^{′} \\ 3 & 4 & {2}^{′} & {1}^{′} & 5 & 6 & 7 & 8 \\ 7 & 8 & {6}^{′} & {5}^{′} & {4}^{′} & {3}^{′} & {2}^{′} & {1}^{′} \\ {2}^{′} & {1}^{′} & 3 & 4 & 5 & 6 & 7 & 8 \\ {6}^{′} & {5}^{′} & 7 & 8 & {4}^{′} & {3}^{′} & {2}^{′} & {1}^{′} \\ {4}^{′} & {3}^{′} & {2}^{′} & {1}^{′} & 5 & 6 & 7 & 8 \\ {8}^{′} & {7}^{′} & {6}^{′} & {5}^{′} & {4}^{′} & {3}^{′} & {2}^{′} & {1}^{′}\end{matrix} ]$$

M₄ corresponds to the entries of Table 2.

As discussed above, each stage transforms the co-channel reuse by a factor of 2. Assuming uniform loading, this gives the smallest granularity in the reuse partitioning and is the ideal solution when the total number of resources (slots) per co-channel cell, N=2ⁿ, for integer n. However, if the total number of slots is not 2ⁿ, then there are a few choices:
1. Regroup and redefine the resources so that the resulting total number of resources is 2″.

Then apply the procedure as defined in section 5.

### EXAMPLE 9

If total number of slots=17, create 2⁴=16 timeslot sets where each set has 1 slot except set 1 which contains slots 1 and 2.

The Examples 4-7 illustrate this approach in detail.
2. If the total number of slots, N—after regrouping and redefining—is not 2ⁿ, then the reuse factors at each stage of progressive reuse need to be determined from the integer factors of N. For reuse transformations by factors other than 2, a procedure such as that in section 5 would have to be devised. It would be more complicated and moreover, the reuse granularity is larger.

### EXAMPLE 10

If the total number of slots=7, create 6 timeslot sets where each set has 1 slot except set 1 which contains slots 1 and 2. However, 6 ≠2ⁿ. The factors of 6 are 6=2×3. Therefore, the progressive reuse stages can be one of 6→3→1 or 6→2→1.

Alternatively, create 4 timeslot sets where each set has 2 consecutive slots except set 4 which contains only one slot, slot number 7. Since 4=2², the procedure in section 5 can then be applied and the resulting progressive reuse stages are 4→2→1.

Various performance examples for EDGE compact and classic scenarios will now be described.

GSM systems are usually planned on the basis of 4/12 (4 base stations, 3 sectors each, per cluster) or 3/9 frequency arrangements. The carriers that contain broadcast control channels (BCCH carriers) are required to transmit continuously and without hopping on control time slots to facilitate handoff measurements control channel acquisition, and so on. These carriers usually are arranged in a 4/12 reuse pattern. Traffic channels can frequency-hop and, on non-BCCH carriers, they can use discontinuous transmission (based on voice-activity detection), and if so, typically are arranged in a 3/9 reuse pattern. These arrangements provide the strong SIR protection typically required for delay-intolerant voice services and non-acknowledged control channels. EDGE “Classic” is defined to be a system using a continuous BCCH carriers that are typically in a 4/12 or 3/9 reuse pattern and which requires at least 2.4 MHz bandwidth in each direction. Additional traffic carriers, if available with higher total bandwidth, can be deployed under a lower reuse factor.

Some system operators, particularly those in North American where 3G spectrum has been partially allocated for PCS, have to re-allocate in-service spectrum to deploy EDGE. In that case, EDGE Compact may be used for initial deployment using as little as 1 MHz in each direction allowing only three 200-KHz frequency carriers. This means allocating one frequency to each of the three sectors per base station, and the frequency set is reused at every base station (“1/3 reuse” for EDGE “Compact” mode). While good spectrum efficiency is achieved, the provisioning of common control functionality, such as system broadcast information, paging, packet access and packet grant, cannot be deployed with 1/3 reuse. 4/12 or 3/9 reuse is required for reliable control channels. In order to achieve adequate cochannel reuse protection for the control channels, reuse in the time domain is exploited, which requires frame synchronization of base stations (BS's).

The minimum spectrum required for Compact deployment is 600 kHz and that for classic is 2.4 MHz (neglecting guard band in both cases). Therefore, at 2.4 MHz and above, there exists the option of either Compact or Classic deployment. The choice of system is partly dependent on the performance of the systems. The performance in turn is dependent on the reuse configuration employed in the deployment. For the purposes of this study and to enable valid comparisons, the reuse configurations are such that control channels are always at 4/12 reuse while traffic channels are at 1/3 reuse whenever possible. The exceptions are the traffic channels of a Classic control (BCCH) carrier, which are at 4/12 reuse because of the continuous nature of the Classic control carrier. We also consider the same control-channel capacity (one active slot of a carrier) for both cases under all scenarios. Error! Reference source not found.4 and the text following describe the scenarios considered:

TABLE 4
Deployment Scenarios

| | | | Carriers | Control Timeslots | Traffic Timeslots per | |
|---|---|---|---|---|---|---|
| | | | per | per Sector (4/12 | Sector | |
| Scenario | Spectrum | Deployment | Sector | reuse) | 4/12 reuse | 1/3 reuse |
| 1 | 600 kHz | Compact | 1 | 4 (1 active, 3 idle) | 0 | 4 |
| 2 | 2.4 MHz | Compact | 4 | 4 (1 active, 3 idle) | 0 | 28 |
| 3 | | Classic | 1 | 1 | 7 | 0 |
| 4 | 4.2 MHz | Compact | 7 | 4 (1 active, 3 idle) | 0 | 52 |
| 5 | | Classic | 4 | 1 | 7 | 24 |

a) 600 kHz deployment

i. Compact (Scenario 1)

There are three 200 kHz carriers, one per sector of a tri-sectored base station. A carrier in a given sector can use the even-numbered slots and the unused portion of the odd-numbered control slots for traffic in a 1/3 reuse. Here, we do not consider the unused portion of the odd-numbered control slots.

b) 2.4 MHz deployment

i. Compact (Scenario 2)

There are twelve 200 kHz carriers. Three of the carriers are deployed in a configuration identical to that of the 600 kHz deployment. The remaining nine carriers are dedicated to traffic and deployed in a 1/3 reuse configuration. Therefore, any given sector of a tri-sectored base station has four carriers, three of which have eight traffic slots each and the fourth has four traffic slots, all in a 1/3 reuse pattern.

ii. Classic (Scenario 3)

There are twelve 200 kHz carriers, all continuous control carriers with one allocated per sector of a trisectored base station. Therefore, a given sector has one carrier of which one slot is dedicated for control and seven slots are dedicated for traffic. All control and traffic slots are in a 4/12 reuse configuration.

c) 4.2 MHz deployment

i. Compact (Scenario 4)

There are twenty-one 200 kHz carriers. Three of the carriers are deployed in a configuration identical to that of the 600 kHz deployment. The remaining eighteen carriers are dedicated to traffic and deployed in a 1/3 reuse configuration. Therefore any given sector of a tri-sectored base station has seven carriers, six of which have eight traffic slots each and the seventh has four traffic slots, all in a 1/3 reuse pattern.

ii. Classic (Scenario 5)

There are twenty-one 200 kHz carriers, twelve of which are in a 4/12 reuse pattern and the remaining nine in a 1/3 reuse pattern. Therefore, a given sector of a tri-sectored base station has four carriers. One of these is the continuous control carrier and it has seven slots dedicated for traffic in a 4/12 reuse pattern. The other three carriers have a total of twenty-four slots in a 1/3 reuse pattern.

10 Performance Comparison

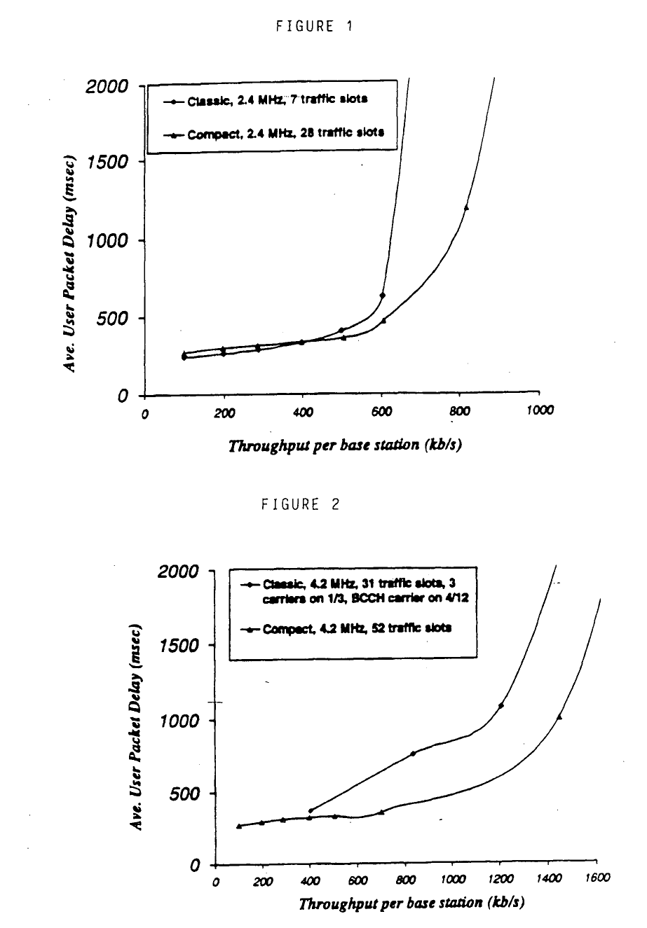

FIGS. 1 and 2 show the average user-packet delay as the throughput per base station (in three sectors) increases for the 2.4 MHz and −4.2 MHz scenarios, respectively. Here we can clearly see the trade-off between QoS, as determined by the delay experienced by the web-browsing users, and the system capacity, as indicated by the total throughput that a typical BS can deliver to all users who are sharing the radio resources.

Note that with aggressive frequency reuse, EDGE Compact achieves higher efficiency due to additional traffic capacity that can be provided for the same bandwidth compared to EDGE Classic. It is therefore a viable option not only for an initial deployment but also for a system with higher available bandwidth. However, the requirement of synchronized base stations and other related issues must be carefully addressed in practical deployment.

It should be obvious from the above-discussed apparatus embodiment that numerous other variations and modifications of the apparatus of this invention are possible, and such will readily occur to those skilled in the art, Accordingly, the scope of this invention is not to be limited to the embodiment disclosed, but is to include any such embodiments as may be encompassed within the scope of the claims appended hereto.

1. A method for radio resource allocation in a wireless cellular system that employs frequency reuse, said method comprising the steps of:
measuring cellular traffic load in said system as a function of available spectrum;
allocating co-channel resources within said system; and
progressively changing said co-channel resource allocation as said traffic load changes in accordance with a predetermined priority in order to maximize the carrier to interference ratio.

2. The method of claim 1 wherein the co-channel resources in the system comprise multiple timeslots on an RF channel and traffic in the system is assigned based on a fixed priority allocation between the multiple timeslots.

3. The method of claim 2 wherein the system comprises multiple cells each with a given set of users and the fixed priority allocation is between said given set of users.

4. The method of claim 3 wherein the system is a wireless packet network.

5. The method of claim 4 wherein the co-channel resources have a fixed frequency spectrum.
